(19) United States
(12) Patent Application Publication
(10) Pub. No.: US 2014/0172619 A1
(43) Pub. Date: Jun. 19, 2014

(54) Aircraft Sales Tool

(71) Applicant: BELL HELICOPTER TEXTRON INC., Fort Worth, TX (US)

(72) Inventors: Andrew J. Zahasky, North Richland Hills, TX (US); Michael Mason, Bedford, TX (US); Keith L. Croney, Colleyville, TX (US); Jerome R. Ries, Fort Worth, TX (US); Richard P. Lefrancois, II, Fort Worth, TX (US); Michael A. Gralish, Arlington, TX (US)

(73) Assignee: BELL HELICOPTER TEXTRON INC., Fort Worth, TX (US)

(21) Appl. No.: 13/715,450

(22) Filed: Dec. 14, 2012

(51) Int. Cl. G06Q 30/06

(52) U.S. Cl. CPC G06Q 30/0621
USPC 705/26.5

(57) ABSTRACT

According to one embodiment, an aircraft sales tool may receive identification of a base aircraft, at least one equipment option, a number of passengers, and a geographic location from a customer. A configuration assessment engine may estimate a range of a configured aircraft based on the received identification of a base aircraft, at least one equipment option, a number of passengers, and a geographic location.

### TECHNICAL FIELD

This invention relates generally to aircraft configurations, and more particularly, to an aircraft sales tool.

### BACKGROUND

An aircraft, such as a rotorcraft, may include a variety of equipment options. Some of these equipment options may change performance of the aircraft. For example, some equipment options may change the range of the aircraft.

### SUMMARY

Particular embodiments of the present disclosure may provide one or more technical advantages. A technical advantage of one embodiment may include the capability to provide customers with aircraft range estimations during the buying process. A technical advantage of one embodiment may also include the capability to allow customers to see how equipment options impact aircraft range.

Certain embodiments of the present disclosure may include some, all, or none of the above advantages. One or more other technical advantages may be readily apparent to those skilled in the art from the figures, descriptions, and claims included herein.

### BRIEF DESCRIPTION OF THE DRAWINGS

To provide a more complete understanding of the present invention and the features and advantages thereof, reference is made to the following description taken in conjunction with the accompanying drawings, in which:

FIG. 1 shows a rotorcraft according to one example embodiment;

FIG. 2 shows an aircraft sales system according to one example embodiment; and

FIG. 3 shows an example display that may be provided to a customer using the aircraft sales system of FIG. 2.

### DETAILED DESCRIPTION OF THE DRAWINGS

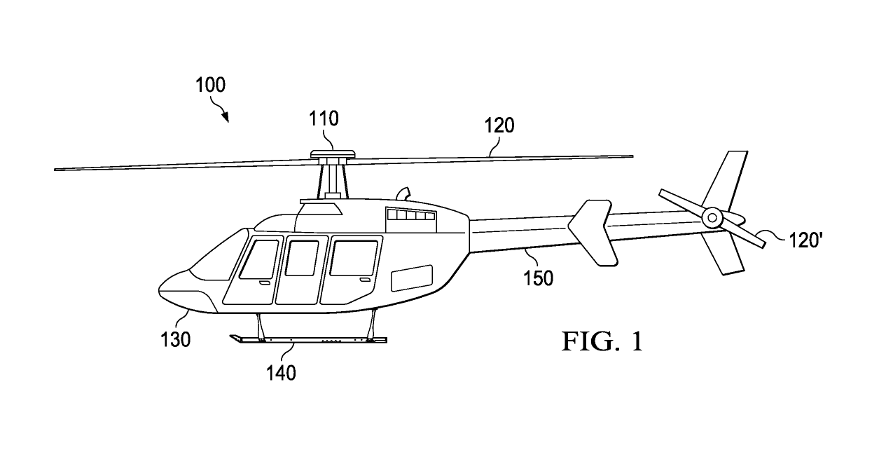

FIG. 1 shows a rotorcraft 100 according to one example embodiment. Rotorcraft 100 features a rotor system 110, blades 120, a fuselage 130, a landing gear 140, and an empennage 150. Rotor system 110 may rotate blades 120. Rotor system 110 may include a control system for selectively controlling the pitch of each blade 120 in order to selectively control direction, thrust, and lift of rotorcraft 100. Fuselage 130 represents the body of rotorcraft 100 and may be coupled to rotor system 110 such that rotor system 110 and blades 120 may move fuselage 130 through the air. Landing gear 140 supports rotorcraft 100 when rotorcraft 100 is landing and/or when rotorcraft 100 is at rest on the ground. Empennage 150 represents the tail section of the aircraft and features components of a rotor system 110 and blades 120′. Blades 120′ may provide thrust in the same direction as the rotation of blades 120 so as to counter the torque effect created by rotor system 110 and blades 120. Teachings of certain embodiments relating to rotor systems described herein may apply to rotor system 110 and/or other rotor systems, such as other tilt rotor and helicopter rotor systems. It should also be appreciated that teachings regarding rotorcraft 100 may apply to aircraft and vehicles other than rotorcraft, such as airplanes and unmanned aircraft, to name a few examples.

An aircraft, such as rotorcraft 100, may serve in a variety of different missions. For example, rotorcraft 100 may transport people, provide reconnaissance, and/or engage in combat. Such missions may vary in length, with some aircraft traveling longer distances when performing certain missions. In addition, some aircraft encounter a variety of different environmental conditions when performing missions, such as nautical, arctic, and desert conditions.

Aircraft such as rotorcraft 100 may be customized to perform certain missions. In particular, optional equipment may be added to rotorcraft 100 to perform certain missions in certain environments. For example, an aircraft may be equipped with weapons for performing combat missions or may be equipped with a cargo hook for hauling equipment.

A customer (including a potential customer) interested in purchasing an aircraft such as rotorcraft 100 may wish to customize the aircraft for performing a certain mission in a certain environment. In addition, the customer may desire additional optional equipment that, even if not essential for a particular mission, may still be an asset on the aircraft.

The customer may also have range requirements associated with a mission. For example, a helicopter configured to transport personnel to and from an off-shore oil platform should have enough range to travel to and from the platform without stopping for fuel.

In this and other examples, the customer may not be aware how adding optional equipment changes the range of the aircraft. In particular, for some aircraft, range may increase dramatically as weight increases, but the customer may not be aware of how each additional pound reduces the range of the aircraft. Thus, the customer may order an aircraft with optional equipment that does not satisfy the range requirements for a particular mission. If the customer was aware that a certain configuration of optional equipment resulted in an aircraft range less than the required range for a particular mission, the customer may prefer to change which optional equipment will be added onto the aircraft.

Accordingly, teachings of certain embodiments recognize the capability to provide customers with aircraft range estimations during the buying process. Teachings of certain embodiments also recognize the capability to allow customers to see how equipment options impact aircraft range.

Teachings of certain embodiments also recognize that estimations may be sufficient for the early stages of the sales experience. Thus, teachings of certain embodiments recognize the capability to provide such range estimations quickly and without the need for a lengthy and complicated engineering process.

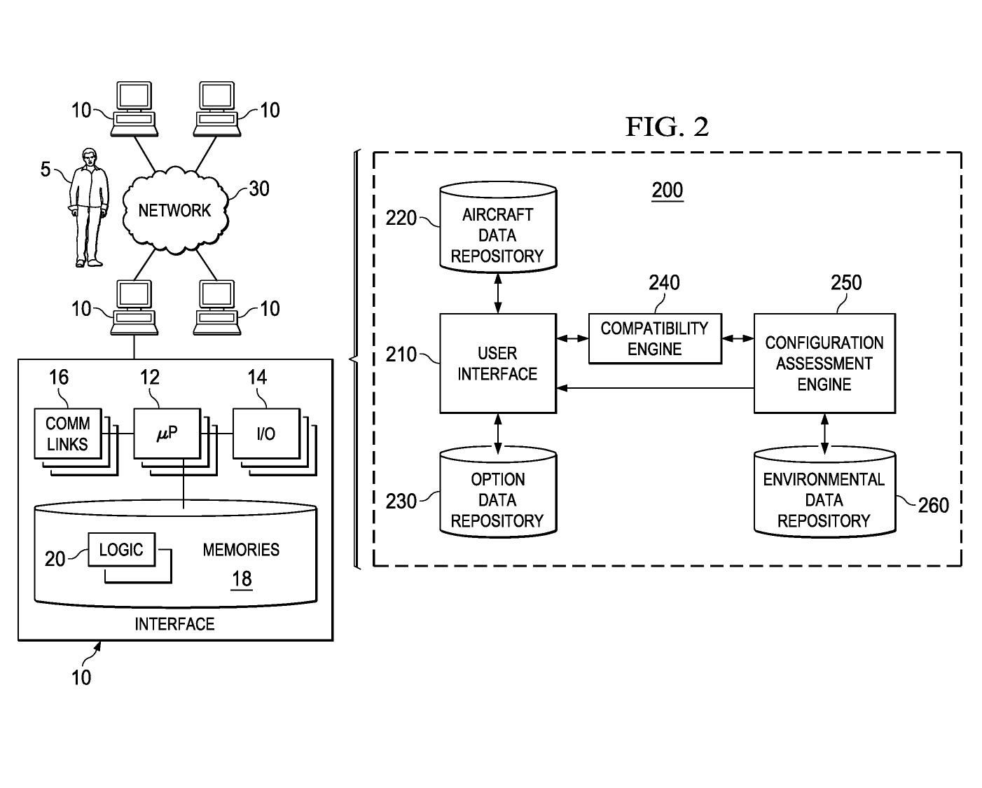

FIG. 2 shows an aircraft sales system 200 according to one example embodiment. In general, system 200 features a user interface 210, an aircraft data repository 220, an option data repository 230, a compatibility engine 240, a configuration assessment engine 250, and an environmental data repository 260, which may be implemented by one or more computer systems 10.

Users 5 may access system 200 through computer systems 10. For example, in some embodiments, users 5 may access user interface 210 through computer systems 10. Users 5 may include any individual, group of individuals, entity, machine, and/or mechanism that interacts with computer systems 10. Examples of users 5 include, but are not limited to, a customer, a pilot, service person, engineer, technician, contractor, agent, and/or employee. Users 5 may be associated with an organization. An organization may include any social arrangement that pursues collective goals. One example of an organization is a business. A business is an organization designed to provide goods or services, or both, to consumers, governmental entities, and/or other businesses.

Computer system 10 may include processors 12, input/output devices 14, communications links 16, and memory 18. In other embodiments, computer system 10 may include more, less, or other components. Computer system may be operable to perform one or more operations of various embodiments. Although the embodiment shown provides one example of computer system 10 that may be used with other embodiments, such other embodiments may utilize computers other than computer system 10. Additionally, embodiments may also employ multiple computer systems 10 or other computers networked together in one or more public and/or private computer networks, such as one or more networks 30.

Processors 12 represent devices operable to execute logic contained within a medium. Examples of processor 12 include one or more microprocessors, one or more applications, and/or other logic. Computer system 10 may include one or multiple processors 12.

Input/output devices 14 may include any device or interface operable to enable communication between computer system 10 and external components, including communication with a user or another system. Example input/output devices 14 may include, but are not limited to, a mouse, keyboard, display, and printer.

Network interfaces 16 are operable to facilitate communication between computer system 10 and another element of a network, such as other computer systems 10. Network interfaces 16 may connect to any number and combination of wireline and/or wireless networks suitable for data transmission, including transmission of communications. Network interfaces 16 may, for example, communicate audio and/or video signals, messages, internet protocol packets, frame relay frames, asynchronous transfer mode cells, and/or other suitable data between network addresses. Network interfaces 16 connect to a computer network or a variety of other communicative platforms including, but not limited to, a public switched telephone network (PSTN); a public or private data network; one or more intranets; a local area network (LAN); a metropolitan area network (MAN); a wide area network (WAN); a wireline or wireless network; a local, regional, or global communication network; an optical network; a satellite network; a cellular network; an enterprise intranet; all or a portion of the Internet; other suitable network interfaces; or any combination of the preceding.

Memory 18 represents any suitable storage mechanism and may store any data for use by computer system 10. Memory 18 may comprise one or more tangible, computer-readable, and/or computer-executable storage medium. Examples of memory 18 include computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server), and/or other computer-readable medium.

In some embodiments, memory 18 stores logic 20. Logic 20 facilitates operation of computer system 10. Logic 20 may include hardware, software, and/or other logic. Logic 20 may be encoded in one or more tangible, non-transitory media and may perform operations when executed by a computer. Logic 20 may include a computer program, software, computer executable instructions, and/or instructions capable of being executed by computer system 10. Example logic 20 may include any of the well-known OS2, UNIX, Mac-OS, Linux, and Windows Operating Systems or other operating systems. In particular embodiments, the operations of the embodiments may be performed by one or more computer readable media storing, embodied with, and/or encoded with a computer program and/or having a stored and/or an encoded computer program. Logic 20 may also be embedded within any other suitable medium without departing from the scope of the invention.

Various communications between computers 10 or components of computers 10 may occur across a network, such as network 30. Network 30 may represent any number and combination of wireline and/or wireless networks suitable for data transmission. Network 30 may, for example, communicate internet protocol packets, frame relay frames, asynchronous transfer mode cells, and/or other suitable data between network addresses. Network 30 may include a public or private data network; one or more intranets; a local area network (LAN); a metropolitan area network (MAN); a wide area network (WAN); a wireline or wireless network; a local, regional, or global communication network; an optical network; a satellite network; a cellular network; an enterprise intranet; all or a portion of the Internet; other suitable communication links; or any combination of the preceding. Although the illustrated embodiment shows one network 30, teachings of certain embodiments recognize that more or fewer networks may be used and that not all elements may communicate via a network. Teachings of certain embodiments also recognize that communications over a network is one example of a mechanism for communicating between parties, and any suitable mechanism may be used.

User interface 210 receives information from and provides information to user 5. In some example embodiments, user interface 210 may be associated with a software application or web interface, such as a tablet application or a website. In some examples, user interface 210 receives information from and provides information to a customer (or potential customer). In these examples, access to user interface 210 may be controlled or limited by another user 5, such as a salesperson.

Aircraft data repository 220 stores information about aircraft available for sale. Examples of information stored in aircraft data repository 220 may include prices, descriptions, pictures, specifications and performance data. In particular, aircraft data repository 220 may store information such as weight and range information for each base aircraft available for sale.

Option data repository 230 stores information about equipment options that may be added to a base aircraft. Examples of information stored in option data repository 230 may include prices, descriptions, pictures, specifications, and performance data. In particular, option data repository 230 may store information such as weight and installation information.

Compatibility engine 240 analyzes equipment options selected by user 5. For example, compatibility engine 240 may analyze whether multiple equipment options are compatible. Two or more equipment options may not be compatible if they may not be installed on the same aircraft at the same time. Two or more equipment options may not be compatible, for example, if they share the same physical space. For example, a camera option and a weapons option may not be compatible if they must be installed in the same location. As another example, skid-gear and wheel-gear landing kits may be incompatible because they cannot be installed on the aircraft together. Compatibility engine 240 may reject a proposed selection of equipment options if they are not compatible, and user interface 210 may inform user 5 that the equipment option selection has been rejected.

Configuration assessment engine 250 analyzes a configured aircraft based on the selections of user 5. In some example embodiments, configuration assessment engine 250 estimates the range of a base aircraft selected by user 5 based on the selections of user 5.

In some estimations, range of an aircraft may be a function of environmental conditions. For example, range of an aircraft may be a function of air pressure, temperature, density, and/or viscosity. These and other environmental conditions may vary depending on location and/or altitude. A customer may not know the environmental conditions in which the aircraft will be flying, however. Accordingly, teachings of certain embodiments recognize the capability to estimate environmental conditions based on a geographic location provided by the customer.

Environmental data repository 260 stores environmental condition information for different geographic locations. In some embodiments, environmental data repository 260 provides environmental condition estimates to configuration assessment engine 250 based on the geographic location provided by user 5, and configuration assessment engine 250 estimates the range of a configured aircraft based at least in part on the provided environmental condition estimates.

In some embodiments, user 5 provides a three-dimensional geographic location, such as by providing an altitude paired with latitude/longitude coordinates or with an address (such as a city or street address). In some examples, user 5 provides an estimated flight altitude, which may be measured, for example, from above sea level or above local elevation. If user 5 provides an estimated flight altitude above local elevation, environmental data repository 260 may determine the ground elevation at the geographic location (e.g., the elevation of Denver, Colo.) and add the flight altitude provided by user 5 to yield an estimated flight altitude above sea level.

User 5 may not necessarily know what elevation at which the aircraft will be flying. Accordingly, in some embodiments, user 5 may provide a two-dimensional geographic location, such as by providing latitude/longitude coordinates or an address. In this example, environmental data repository 260 may determine the flight altitude based on the ground elevation at the geographic location and a standard flight altitude. In some examples, the standard flight altitude may be unique to each base aircraft based on the capabilities of each base aircraft.

Environmental data repository 260 may provide environmental condition estimates to configuration assessment engine 250 based on the geographic location provided by user 5. In one example embodiment, environmental data repository 260 may estimate environmental conditions based on the International Standard Atmosphere (ISA) model. The ISA model is an atmospheric model of how pressure, temperature, density, and viscosity of the Earth's atmosphere change over a wide range of altitudes. ISA may provide a common reference for temperature and pressure and include tables of values at various altitudes, plus some formulae by which those values were derived. The International Organization for Standardization (ISO) publishes the ISA as an international standard, ISO 2533:1975. In some embodiments, standards other than the ISA model may be used. For example, other standards organizations, such as the International Civil Aviation Organization (ICAO) and the U.S. Government, publish extensions or subsets of the same atmospheric model under their own standards-making authority. In addition, environmental data repository 260 may allow deviations from a standard model based on known natural deviations (e.g., known geographic locations that deviate from the standard model) and/or input from user 5. In addition, the environmental condition estimates provided by environmental data repository 260 may be adjusted to provide a safety tolerance for range calculations.

In operation, according to example embodiments, user interface 210 receives, from user 5, identification of a base aircraft, at least one equipment option, a number of passengers, and a geographic location. Aircraft data repository 220 provides the weight of the base aircraft identified by user 5. Option data repository 230 provides the weight of at least one equipment option identified by user 5.

In addition, aircraft data repository 220 may provide aircraft sales information about the base aircraft, including a picture, a price, and a description associated with the base aircraft. In some embodiments, this aircraft sales information is provided by aircraft data repository 220 and displayed by user interface 210 in response to identification of the base aircraft by user 5. In other embodiments, the aircraft sales information is not provided by aircraft data repository 220 and displayed by user interface 210 in response to identification of the base aircraft by user 5. For example, user interface 210 may display the aircraft sales information for a base aircraft before user 5 selects the base aircraft (e.g., user interface 210 provides aircraft sales information about a variety of aircraft, and user 5 is provided an opportunity to select a base aircraft).

In these example embodiments, configuration assessment engine 250 may estimate a range of the configured aircraft identified by user 5. For example, configuration assessment engine 250 may estimate an overall weight of the configured aircraft as a function of the weight of the base aircraft (such as provided by aircraft data repository 220), the weight of the at least one equipment option (such as provided by option data repository 230), and a weight associated with the number of passengers identified by user 5. In addition, configuration assessment engine 250 may receive estimated environmental information from environmental data repository 260, which may estimate the environmental information from geographic location information provided by user 5. Configuration assessment engine 250 may then estimate the range of the configured aircraft based on the overall weight and estimated environmental information.

Configuration assessment engine 250 may estimate the range of the configured aircraft based on the overall weight and estimated environmental information in a variety of ways. In one example, range information may be determined for each base aircraft as a function of weight and environmental conditions. For example, each base aircraft may have pre-flight tables and graphs that allow the range to be estimated as a function of weight and environmental conditions; in this example, configuration assessment engine 250 may apply formulas representative of these tables and graphs (e.g., each formula may be a curve fit from a pre-flight range graph). In this manner, configuration assessment engine 250 may rely on preexisting range calculations to estimate range for a potential customer.

In the preceding example, configuration assessment engine 250 may not necessarily estimate range as a function of drag. Rather, 100 pounds of passenger or options inside the fuselage may be treated as equal to 100 pounds of equipment installed outside the aircraft. Teachings of certain embodiments recognize that ignoring drag may simplify calculations while allowing for sufficient range estimation for sales purposes.

Teachings of certain embodiments also recognize, however, the capability to improve range estimations by accounting for how drag may reduce range of an aircraft. In one example embodiment, each equipment option may have an associated drag penalty (for those equipment options that do not cause drag, the drag penalty may be nominal or zero). In this example, configuration assessment engine 250 may estimate the range of the configured aircraft as a function of these drag penalties. In one example, a camera installed outside the aircraft may be estimated to reduce range by five percent; in this example, configuration assessment engine 250 may apply a five percent penalty to the range calculations described above.

User interface 210 may provide the estimated range to user 5. User interface 210 may also provide additional information about the configured aircraft, such as a price of the configured aircraft (based, for example, on the price of the base aircraft, the price of the equipment options, and delivery costs), a description of the configured aircraft, a picture of the configured aircraft, and a delivery date for the configured aircraft.

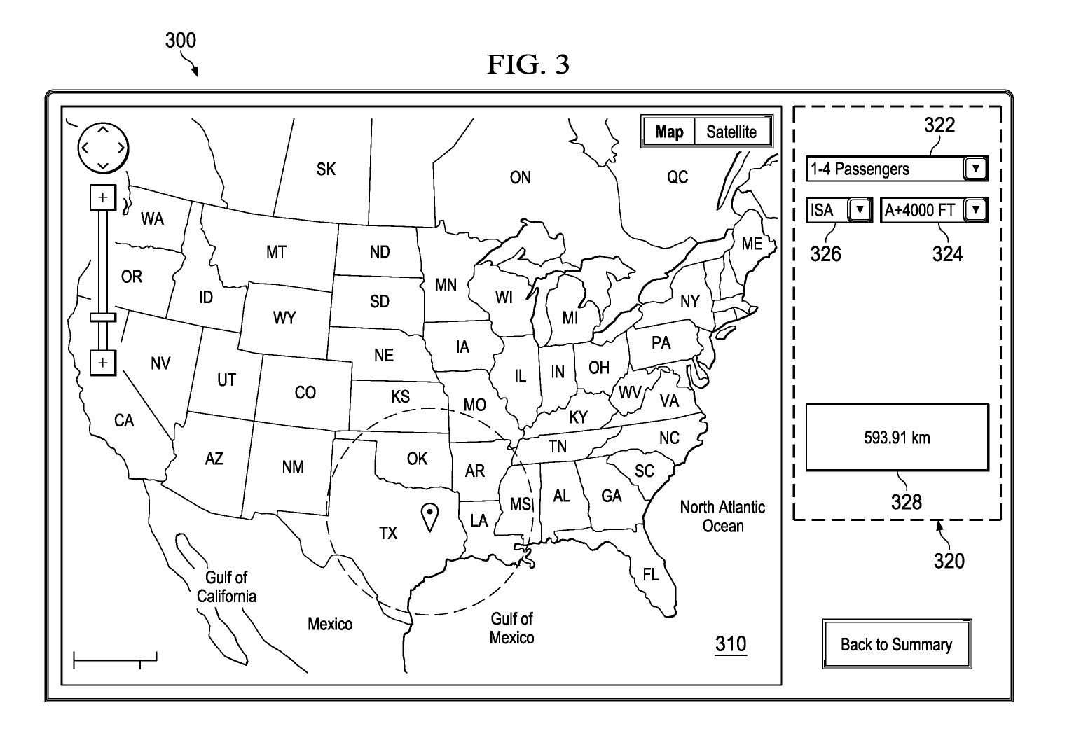

FIG. 3 shows an example display 300 that may be provided through user interface 210 to user 5. Display 300 features a map 310 and an information panel 320. Map 310 shows one example of a geographic representation of the estimated range of a configured aircraft based on the geographic location identified by the customer. In this example, the customer identified a location in north Texas, and the range of the aircraft extends from Missouri to Mexico.

Information panel 320 provides additional information about the configured aircraft and its range. In the example of FIG. 3, information panel 320 features customer selection inputs 322, 324, and 326 and range output 328. Customer selection input 322 allows the customer to select a number of passengers (e.g., 1-4 passengers). Customer selection input 324 allows the customer to select an flight altitude (e.g., 4000 feet). Customer selection input 326 allows the customer to select an atmospheric model (e.g., ISA model). Range output 328 provides a numerical representation of the range of the configured aircraft based on inputs 322-326 and other inputs. In the example of FIG. 3, the configured aircraft has a range of 593.91 kilometers. In some embodiments, information panel 320 may include additional information, such as a total weight of the configured aircraft (e.g., total empty weight, total loaded weight), a total price (including equipment options), a picture of the configured aircraft, and/or a description of the configured aircraft.

Modifications, additions, or omissions may be made to the systems and apparatuses described herein without departing from the scope of the invention. The components of the systems and apparatuses may be integrated or separated. Moreover, the operations of the systems and apparatuses may be performed by more, fewer, or other components. The methods may include more, fewer, or other steps. Additionally, steps may be performed in any suitable order.

Although several embodiments have been illustrated and described in detail, it will be recognized that substitutions and alterations are possible without departing from the spirit and scope of the present invention, as defined by the appended claims.

To aid the Patent Office, and any readers of any patent issued on this application in interpreting the claims appended hereto, applicants wish to note that they do not intend any of the appended claims to invoke paragraph 6 of 35 U.S.C. §112 as it exists on the date of filing hereof unless the words “means for” or “step for” are explicitly used in the particular claim.

What is claimed is:

1. An aircraft sales tool, comprising:
a customer input interface operable to receive identification of a base aircraft, at least one equipment option, a number of passengers, and a geographic location from a customer;
an aircraft sales repository operable to provide a weight of the base aircraft and aircraft sales information comprising a picture of the base aircraft, a price associated with the base aircraft, and a description associated with the base aircraft;
an option repository operable to provide, in response to the customer selection of the at least one equipment option, a weight of the at least one equipment option;
an environmental information repository operable to provide estimated environmental information as a function of the geographic location identified by the customer;
a configuration assessment engine operable to:
estimate an overall weight of a configured aircraft as a function of the weight of the base aircraft, the weight of the at least one equipment option, and a weight associated with the number of passengers; and
estimate a range of the configured aircraft based on the overall weight and the estimated environmental information; and
a customer output interface operable to provide, to the customer, the aircraft sales information and the estimated range.

2. The aircraft sales tool of claim 1, wherein the customer input interface is operable to receive identification of at least two equipment options from the customer, the configuration assessment engine further operable to reject the at least two equipment options identified by the customer if the at least two equipment options are not compatible together.

3. The aircraft sales tool of claim 2, wherein two equipment options are not compatible if they require the same physical space on the base aircraft.

4. The aircraft sales tool of claim 1, wherein the customer output interface is further configured to provide an estimated delivery date of the configured aircraft.

5. The aircraft sales tool of claim 1, wherein the customer output interface is operable to provide the price associated with the base aircraft by providing a price of the configured aircraft.

6. The aircraft sales tool of claim 1, wherein the customer output interface is operable to provide the description associated with the base aircraft by providing a description of the configured aircraft.

7. The aircraft sales tool of claim 1, wherein the customer output interface is operable to provide the picture of the base aircraft by providing a picture of the configured aircraft.

8. The aircraft sales tool of claim 1, wherein:
the option repository is operable to provide, in response to the customer selection of the at least one equipment option, a drag penalty associated with the at least one equipment option; and
the configuration assessment engine is operable to estimate the range of the configured aircraft based on the drag penalty, the overall weight, and the estimated environmental information.

9. The aircraft sales tool of claim 1, wherein the aircraft sales repository is configured provide the aircraft sales information in response to the customer selection of the base aircraft.

10. The aircraft sales tool of claim 1, wherein providing the estimated range of the configured aircraft comprises providing a geographic representation of the estimated range based on the geographic location identified by the customer.

11. A method of assisting a customer in selecting an aircraft, comprising:
receiving identification of a base aircraft, at least one equipment option, a number of passengers, and a geographic location from a customer;
providing a weight of the base aircraft and aircraft sales information comprising a picture of the base aircraft, a price associated with the base aircraft, and a description associated with the base aircraft;
providing, in response to the customer selection of the at least one equipment option, a weight of the at least one equipment option;
estimating an overall weight of a configured aircraft as a function of the weight of the base aircraft, the weight of the at least one equipment option, and a weight associated with the number of passengers;
estimating environmental information as a function of the geographic location identified by the customer; and
estimating a range of the configured aircraft based on the overall weight and the estimated environmental information; and
providing, to the customer, the aircraft sales information and the estimated range.

12. The method of claim 11, wherein receiving identification of the at least one equipment option comprises receiving at least two equipment options from the customer, the method further comprising rejecting the at least two equipment options identified by the customer if the at least two equipment options are not compatible together.

13. The method of claim 12, wherein two equipment options are not compatible if they require the same physical space on the base aircraft.

14. The method of claim 11, further comprising providing an estimated delivery date of the configured aircraft to the customer.

15. The method of claim 11, wherein providing the price associated with the base aircraft comprises by providing a price of the configured aircraft.

16. The method of claim 11, wherein providing the description associated with the base aircraft comprises providing a description of the configured aircraft.

17. The method of claim 11, wherein providing the picture of the base aircraft comprises providing a picture of the configured aircraft.

18. The method of claim 11, further comprising:
providing, in response to the customer selection of the at least one equipment option, a drag penalty associated with the at least one equipment option; and
estimating the range of the configured aircraft based on the drag penalty, the overall weight, and the estimated environmental information.

19. The method of claim 11, wherein the aircraft sales information is provided in response to the customer selection of the base aircraft.

20. The method of claim 11, wherein providing the estimated range of the configured aircraft comprises providing a geographic representation of the estimated range based on the geographic location identified by the customer.
